(19) United States
(12) Patent Application Publication
(10) Pub. No.: US 2026/0185576 A1
(43) Pub. Date: Jul. 2, 2026

(54) Brake Element

(71) Applicant: Daniel Hascic, Siegendorf (AT)

(72) Inventor: Daniel Hascic, Siegendorf (AT)

(21) Appl. No.: 19/130,088

(22) PCT Filed: Nov. 14, 2023
(86) PCT No.: PCT/AT2023/060389

§ 371 Date: May 14, 2025

(30) Foreign Application Priority Data
Nov. 16, 2022 (AT) A 50869/2022

(51) Int. Cl. F16D 65/12; F16D 69/00; F16D 69/02

(52) U.S. Cl. CPC F16D 65/127; F16D 69/027; F16D 2069/001; F16D 2200/0021; F16D 2250/0076

(57) ABSTRACT

According to the invention, a brake element (1) is provided, comprising a base body (2) and a friction layer (3), wherein the friction layer (3) comprises a steel which has the following reference analysis:

$$10 - 15 \% by weight Mn$$

$$18 - 24 \% by weight Cr$$

$$< 1 \% by weight Si$$

$$< 1 \% by weight N$$

$$< 0.1 \% by weight C$$

$$Residual Fe .$$

The invention relates to a brake element, comprising a base body and a friction layer.

The invention also relates to a method for producing a brake element according to the invention.

Brake elements of the type mentioned at the beginning are known from the state of the art. Here, a moving, e.g. a rotating element, is touched on its surface by brake pads, creating friction between the moving element and the brake pad. This friction causes a conversion of the kinetic energy of the moving element into thermal energy and thus a deceleration of the moving element. An example of this is a disc brake, in which a rotating brake disc can be braked if necessary with the help of brake blocks that can optionally be pressed against the brake disc and which comprise the brake pads.

During the braking process, the brake elements, e.g. brake discs, are exposed to high loads. On the one hand, material is rubbed off the brake element due to the mechanical load, and on the other hand, the brake element is heated strongly due to the thermal load. As a result, brake elements have to be replaced at regular intervals, e.g. when a wear limit is reached, and replaced with new brake elements in order to ensure proper functioning of the brake elements and thus of the respective brake system.

Well-known brake elements, especially brake discs, are e.g. made of grey cast iron, steel or ceramic. Furthermore, e.g. from the document WO 2020/043712 A1, brake discs are known, which are double-coated. In this case, an intermediate layer is arranged on the base body, which in turn supports a top layer. The intermediate layer, formed from a Ni or Cr alloy, is intended in particular to compensate for temperature-related stresses, while the top layer, consisting of a stainless steel matrix with embedded hard materials, is as hard as possible in order to achieve a long durability.

Document EP 0902099 A1 describes a coating with the following composition (each in mass percent):
12 to 25% chromium (Cr)
0 to 15% manganese (Mn)
2 to 6% molybdenum (Mo)
0 to 15% nickel (Ni)
1%, preferably 2 to 12% vanadium (V)
0 to 5% nitrogen (N)
Residual iron and technically common impurities.

The disadvantage of the well-known brake elements, however, is that the pressure exerted on the brake elements by the brake blocks during braking can damage or wear the surface of the brake elements, especially the friction layer. This material removal unintentionally exposes the material layer originally located below the surface of the brake element and exposes it to the environment. This allows the undesirable formation of corrosion on the brake elements and significantly reduces the lifetime of the brake elements.

It is therefore an object of the invention to provide a brake element which has a lower susceptibility to corrosion. In particular, the brake element is said to have less wear of the friction layer during operation as well as improved damping.

According to the invention, in the case of a brake element of the type mentioned at the beginning, it is provided that the friction layer comprises a steel which has the following reference analysis:

$$10 - 15 \% by weight Mn ( manganese )$$

$$18 - 24 \% by weight Cr ( chromium )$$

$$< 1 \% by weight Si ( silicon )$$

$$< 1 \% by weight N ( nitrogen )$$

$$< 0.1 \% by weight C ( carbon )$$

$$Residual Fe ( iron ) .$$

The steel therefore has no other elements besides the above-mentioned elements, apart from minor impurities.

In order to further reduce the susceptibility to corrosion, the steel is particularly preferred to have the following reference analysis:

$$10 - 11 \% by weight Mn ( manganese )$$

$$18 - 20 \% by weight Cr ( chromium )$$

$$< 1 \% by weight Si ( silicon )$$

$$< 1 \% by weight N ( nitrogen )$$

$$< 0.1 \% by weight C ( carbon )$$

$$Residual Fe ( iron ) .$$

It is preferable provided that the friction layer consists of the steel. On the one hand, the friction layer closes any openings in the surface of the base body, which at the same time increases corrosion protection against the environment and also improves wear and damping of the brake element. In particular, this extends the lifetime of the brake element until it needs to be replaced.

Particularly preferable, the steel has the following reference analysis:

$$10 - 11 \% by weight Mn ( manganese )$$

$$18 - 20 \% by weight Cr ( chromium )$$

$$< 1 \% by weight Si ( silicon )$$

$$< 1 \% by weight Ni ( nickel )$$

$$< 0.1 \% by weight C ( carbon )$$

$$0.06 \% by weight P ( phosphorus )$$

$$0.03 \% by weight S ( sulphur )$$

$$0.4 - 0.65 \% by weight N ( nitrogen )$$

$$< 1 \% by weight Mo ( molybdenum )$$

$$Residual Fe ( iron ) .$$

The steel is preferably a manganese hard steel, especially preferred a manganese hard steel 1.3820 (X8CrMnN20-10).

In the case of a preferred embodiment, it is provided that the friction layer further comprises an alloy which has the following reference analysis:

$$4 - 6 \% by weight Mn ( manganese )$$

$$22 - 28 \% by weight Cr ( chromium )$$

$$3 - 5 \% by weight B ( boron )$$

$$< 1 \% by weight Si ( silicon )$$

$$0.4 - 0.6 \% by weight C ( carbon )$$

$$Residual Fe ( iron ) .$$

In this preferred embodiment, the friction layer consists of a mixture of the steel with the above-mentioned reference analysis and the alloy. The mixing ratio between the steel and the alloy is preferably approx. 80:20, 60:40, 40:60 or 20:80. By providing a mixture of the steel and the alloy, the hardness and strength of the friction layer can be further improved. The steel and the alloy are preferably mixed together in the liquid (molten) state in order to obtain an essentially homogeneous friction layer.

It is preferable that the friction layer has substantially no nickel. Preferably, the friction layer has less than 0.2% nickel by weight, particularly preferred less than 0.1% nickel by weight, and further particularly preferred less than 0.01% nickel by weight. Nickel is considered to be a concern for human health. The provision of a nickel-free friction layer prevents nickel from entering the ambient air through abrasion during braking and then being inhaled.

Furthermore, it is preferable that the friction layer contains substantially no CMR substances. The friction layer preferably has less than 0.2% CMR substances by weight, particularly preferred less than 0.1% CMR substances by weight, and further particularly preferred less than 0.01% CMR substances by weight. CMR substances are carcinogenic, mutagenic or reprotoxic substances that are or may be dangerous to humans. Examples of this are acrylamide, beryllium or chromium trioxide. In order to prevent toxic substances from entering the environment due to the abrasion of the friction layer during use, these are preferably not contained in the friction layer.

It is preferable that the friction layer has a thermal conductivity greater than 1.1 times the thermal conductivity of the base body. Preferably, the thermal conductivity of the friction layer is 1.1 to 10 times greater than the thermal conductivity of the base body. The thermal conductivity of the friction layer is particularly preferred approx. 1.12 to 1.36 times greater than the thermal conductivity of the base body. This embodiment makes it possible for the thermal energy generated during braking to be dissipated to a large extent via the friction layer and the thermal energy dissipated via the base body to be reduced. This allows a reduction in the thermal mass of the base body and thus a reduction in the weight of the brake element.

Preferably, the friction layer has a thermal conductivity of approx. 65 to 85 W/mK. Grey cast iron, a preferred material for the base body, usually has a thermal conductivity of approx. 48 to 52 W/mK.

It is preferable that the friction layer is formed of a stainless steel matrix with hard particles embedded therein. This provides a particularly hard friction layer, which reduces wear of the friction layer and thus of the brake element.

The hard particles include or are preferably chromium carbide particles and/or vanadium carbide particles.

Here, it is preferable that the base body is a grey cast iron or includes a grey cast iron. The grey cast iron, for example, is EN GJL 150. Grey cast iron has carbon in the form of graphite. This graphite can be used, for example, to form hard particles during the application of the friction layer with the help of the heat source and a welding additive, e.g. a powder, in the friction layer, whereby the hard particles are formed as primarily precipitated hard substances when the applied melt solidifies. In this case, the heat source, e.g. a laser, works together with the welding additive, e.g. a powder, and the graphite in the grey cast iron to form the hard particles in the friction layer. The hard particles are therefore formed in the melt and are not supplied via an external source. The resulting hard particles consist of e.g. chromium carbide and/or vanadium carbide. Preferably, the hard particles have an average grain size of approx. 3 to 5 μm. Further preferred, the proportion of hard particles in the friction layer is approx. 20 to 70 vol.-%, preferably 35 to 55 vol.-%, especially preferably 40 to 50 vol.-%, in order to ensure high hardness on the one hand and sufficient strength of the friction layer on the other.

The thickness of the friction layer is preferably 3.5 mm or more. Preferably, the friction layer is arranged directly on the base body, i.e. without an intermediate layer. This allows the heat to be dissipated directly from the friction layer to the base body. Furthermore, this design allows for easy production of the brake element.

The invention also relates to a brake disc, comprising at least one brake element according to the invention. The brake disc is preferably a brake element according to the invention, whereby the base body is particularly preferably ring-shaped. The base body of the brake disc may be coated on one side with a friction layer according to the invention. It is preferred that the base body of the brake disc is coated with a friction layer according to the invention on both sides on two surfaces that are essentially opposite each other. This makes it possible to exert pressure on both sides of the brake disc during braking.

According to the invention, a method for producing a brake element according to the invention is also provided, wherein the friction layer is applied to the base body by cladding. Thus, the base body is first provided, which is then coated with a friction layer with the composition according to the invention by means of a cladding welding process. In cladding, the welding additive material is melted by a heat source, e.g. a laser beam, and applied to the base body. After the applied material has solidified, a solid friction layer is formed. Cladding is suitable for this purpose, as it is a proven process that can be used easily, quickly and cost-effectively to produce the brake element according to the invention.

Furthermore, it is possible that because of the cladding, hard phases in the friction layer form during application, which further reduce the wear of the friction layer. It is preferable that the base body is or comprises a grey cast iron (e.g. EN GJL 150), which causes hard particles to form from the graphite lamellae during cladding as described above. A laser is preferably used as a heat source and a powder as a welding additive material for cladding. It is preferable that no carbides are added to the friction layer, but that the hard particles are formed from the melt exclusively during cladding.

It is preferable that the friction layer is cooled in a controlled manner after application. The cooling does not take place by simply cooling in the air, but the extraction or, if necessary, the introduction of heat to the brake element is controlled in order to obtain the desired cooling curve. The desired cooling behavior depends in particular on the exact composition of the friction layer. Controlled cooling ensures that cracks or other damage in the friction layer or in the transition area between the friction layer and the base body are reduced or avoided as far as possible.

It is preferable to cool the friction layer or the base body after the friction layer has been applied with an essentially linear cooling rate of 25° C. per 10 seconds to 35° C. per 10 seconds, especially preferably approx. 30° C. per 10 seconds. Controlled cooling is preferably carried out up to a temperature of the brake element of approx. 30° C.

After coating the base body with the friction layer, the friction layer can be further processed, e.g. by partially removing the surface of the friction layer to obtain a friction layer of essentially homogeneous thickness.

The invention is explained in more detail below on the basis of an embodiment shown in the drawing.

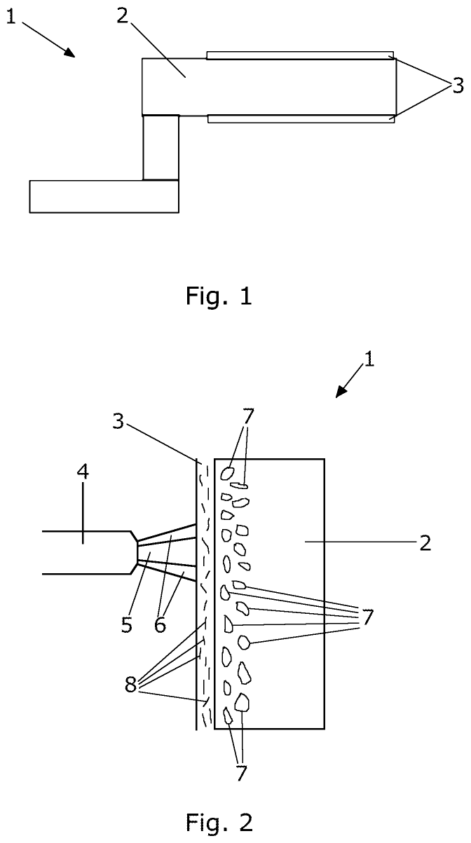

FIG. 1 shows a brake element according to the invention and

FIG. 2 a schematic representation of a method according to the invention.

FIG. 1 shows a brake element 1 according to the invention, comprising a base body 2 and a friction layer 3 applied on both sides. During operation during braking, the friction layer 3 works together with a brake pad, e.g. brake blocks, to slow down the moving brake element 1. In this embodiment, brake pads may be arranged on both sides of the base body 2 in order to exert pressure on the brake element 1 on both sides and thus brake it.

FIG. 2 shows a schematic representation of a method according to the invention for the application of a friction layer 3 according to the invention on a base body 2. The base body 2 is designed as grey cast iron. A processing device 4 applies a laser beam 5 as well as powder 6 on both sides of the laser beam 5 to the surface of the base body 2. The heat of the laser beams 5 creates a local melt from the powder 6 and part of the material of the base body 1, so that the friction layer 3 bonds with the base body 1. In the base body 1, which is formed as grey cast iron, there are graphite lamellae 7 which, during the application of friction layer 3, together with powder 6, form hard particles 8, which after solidification are arranged in the friction layer 3. This creates a particularly hard friction layer 3, which is both less susceptible to wear and less susceptible to corrosion and therefore has a longer lifetime.

1. A brake element, comprising a base body and a friction layer, characterized in that the friction layer is formed of a stainless steel matrix with hard particles embedded therein and the friction layer comprises a steel which has the following reference analysis:
$$10 - 15 \% by weight Mn$$
$$18 - 24 \% by weight Cr$$
$$< 1 \% by weight Si$$
$$< 1 \% by weight N$$
$$< 0.1 \% by weight C$$
$$Residual Fe .$$

2. The brake element according to claim 1, wherein the friction layer further comprises an alloy which has the following reference analysis:
$$4 - 6 \% by weight Mn$$
$$22 - 28 \% by weight Cr$$
$$3 - 5 \% by weight B$$
$$< 1 \% by weight Si$$
$$0.4 - 0.6 \% by weight C$$
$$Residual Fe .$$

3. The brake element according to claim 1, wherein the friction layer has substantially no nickel.

4. The brake element according to claim 1, wherein the friction layer contains substantially no CMR substances.

5. The brake element according to claim 1, wherein the friction layer has a thermal conductivity greater than 1.1 times the thermal conductivity of the base body.

6. A brake disc comprising at least one brake element according to claim 1.

7. A method for producing a brake element according to claim 1, wherein the friction layer is applied to the base body by cladding.

8. The method according to claim 7, wherein the friction layer (3) is cooled in a controlled manner after application.
